(19) United States
(12) Patent Application Publication
(10) Pub. No.: US 2024/0112283 A1
(43) Pub. Date: Apr. 4, 2024

(54) ECOLOGICAL GOVERNANCE METHOD BASED ON EROSION PREVENTION AND CONTROL FOR GENTLE SLOPE FARMLAND

(71) Applicant: Jilin Academy of Agricultural Sciences, Changchun (CN)

(72) Inventors: Weiping Yan, Changchun (CN); Shaofeng Bian, Changchun (CN); Yongjun Wang, Changchun (CN); Hongxiang Zhao, Changchun (CN); Lihua Zhang, Changchun (CN); Baoyu Chen, Changchun (CN); Hongjun Wang, Changchun (CN); Tiehua Cao, Changchun (CN); Xuanhe Liang, Changchun (CN); Guobo Tan, Changchun (CN); Ning Sun, Changchun (CN); Chen Xu, Changchun (CN); Fei Li, Changchun (CN); Xiangmeng Meng, Changchun (CN); Jinghua Wang, Changchun (CN); Qingge Wang, Changchun (CN)

(21) Appl. No.: 18/471,895

(22) Filed: Sep. 21, 2023

(30) Foreign Application Priority Data
Sep. 22, 2022 (CN) 202211160851.3

(51) Int. Cl. G06Q 50/02; A01B 79/02; E02D 3/00

(52) U.S. Cl. CPC G06Q 50/02; A01B 79/02; E02D 3/00

(57) ABSTRACT

The present disclosure provides an ecological governance method based on erosion prevention and control for a gentle slope farmland and relates to the technical field of ecological governance of farmlands. The ecological governance method based on erosion prevention and control for a gentle slope farmland includes the following steps: sampling a gentle slope farmland to investigate erosion thereof; and determining erosion of a gentle slope cultivated land and selecting a corresponding recovery strategy based on a detection result of a sample, a soil quality index (SQI), and a comprehensive vegetation quality index (VQI), where the recovery strategy includes a natural recovery method and a biological-farming comprehensive recovery method; enclosing the gentle slope cultivated land, fallowing the gentle slope cultivated land and reducing tillage; exterminating insect pests and poisonous weeds in the enclosed area; and turning over straws under soil by a cultivator. The growth of poisonous weeds is inhibited.

### CROSS REFERENCE TO RELATED APPLICATION

This patent application claims the benefit and priority of Chinese Patent Application No. 202211160851.3, filed with the China National Intellectual Property Administration on Sep. 22, 2022, the disclosure of which is incorporated by reference herein in its entirety as part of the present application.

### TECHNICAL FIELD

The present disclosure relates to the technical field of ecological governance of farmlands, and in particular, to an ecological governance method based on erosion prevention and control for a gentle slope farmland.

### BACKGROUND

Technical Regulations of Investigation on Land Utilization Status present five slope grades for cultivated land, i.e., <2°, 2° to 6°, 6° to 15°, 15° to 25°, and 25°. Different grades of land surface slopes have different influences on cultivated land utilization, where 6° to 15° and 15° to 25° are of gentle slope cultivated lands, and 25° is of a steep slope cultivated land. For the land surface slopes of <2°, there is generally no water and soil loss; for 2° to 6°, mild soil erosion may occur and attention needs to he paid to water and soil conservation; for 6° to 15°, moderate soil erosion may occur and measures such as terracing and contour farming need to be taken to enhance water and soil conservation; for 15° to 25°, serious soil erosion may occur and comprehensive measures such as engineering and biological measures must be taken to prevent water and soil loss; and 25° is a specified land clearing slope limit, i.e., land clearing for crop planting is prevented and lands that have been reclaimed as cultivated lands should he gradually returned to forests and grasslands.

In general, a gentle slope cultivated land has well-drained fertile soil, which is conducive to plant growth. A steep slope has a thin soil layer with high gravel content in soil, which is disadvantageous to plant growth. However, due to the presence of a slope, in case of rain erosion and wind erosion, the water and soil loss of the gentle slope cultivated land is more serious than that of a flat land.

When the gentle slope cultivated land is of 6° to 25° and has erosion, ecological restoration needs to be carried out therefor. However, existing restoration methods and erosion determination methods are low in qualitative and quantitive degrees and fail to accurately determine the degree of erosion. As a result, regardless of the degree of erosion, the same ecological governance method for erosion prevention and control is selected, leading to poor pertinence of erosion prevention and control and unsatisfactory erosion prevention and control effect.

### SUMMARY

The present summary is provided only by way of example and not limitation. Other aspects of the present invention will be appreciated in view of the entirety of the present disclosure, including the entire text, claims, and accompanying figures.

### (I) Technical Problems to be Solved

In view of the shortcomings of the prior art, the present disclosure provides an ecological governance method based on erosion prevention and control for gentle slope farmland that solves the problems in the background art.

Under proper natural conditions, the self-repair process of the degraded ecosystem is complex and long. Therefore, to recover degraded gentle slope cultivated lands and protect non-degraded gentle slope cultivated lands and to accelerate the vegetation succession process, diversified vegetation ecosystems are artificially configured so that the stability of the degraded ecosystem can be improved, thus increasing the ecological and economic benefits of the gentle slope cultivated land.

Taking certain artificial recovery measures for the degraded gentle slope cultivated lands may cause the forward succession process of the vegetation to accelerate. However, unscientific artificial interference may cause the forward succession process of the vegetation to cease and even result in reverse succession.

The purpose of this is to protect and recover desertificated and potentially desertificated gentle slope cultivated lands. A biological measure mainly refers to recovering the vegetation of the damaged ecosystem using appropriate plants, thereby establishing new plant communities, recovering the degraded ecological environment, and achieving prevention and control for the eroded gentle slope cultivated land.

### II. Technical Solutions

To achieve the above purpose, the present disclosure is implemented by the following technical solutions: an ecological governance method based on erosion prevention and control for a gentle slope farmland includes the following steps: sampling a gentle slope farmland to investigate erosion thereof; and evaluating an erosion degree of a gentle slope cultivated land and formulating a corresponding recovery strategy based on a detection result of a sample, a soil quality index (SQI), and a comprehensive vegetation quality index (VQI), where the recovery strategy includes a natural recovery method and a biological-farming comprehensive recovery method.

Further, the sampling a gentle slope farmland to investigate erosion thereof may include: determining a detection quadrat, and investigating and sampling a quadrat vegetation: sampling quadrat soil, where the detection quadrat is determined as follows: determining a gentle slope between 6 and 25 degrees; and selecting 5 quadrats along an S-shaped curve on the gentle slope, where an area of each quadrat is not less than 1 m²; for example, a size of the quadrat is 1 m * 1 m; and a spacing between the quadrats is at least not less than 20 m.

Further, the investigating and sampling a quadrat vegetation may include: investigating the quadrat vegetation to acquire 4 indexes: above-ground vegetation biomass, vegetation coverage, average vegetation height, and vegetation richness; taking soil samples from 5 layers in each quadrat, mixing soil obtained by triple drilling into a soil sample for measurement of the indexes; acquiring 7 indexes: soil organic matter, microbial carbon, soil total nitrogen, soil total phosphorus, soil total potassium, soil available nitrogen, and soil available phosphorus, and evaluating soil erosion of the farmland.

Further, data of 7 soil indexes may be standardized by normalization formulas:

$${Y}_{i} = \frac{{X}_{i} - min \{ {X}_{i} \}}{max \{ {X}_{i} - min \{ {X}_{i} \}} ( 1 \leq i \leq n ) \qquad ( 1 - 1 )$$

$${V}_{j} = \frac{\sqrt{\frac{1}{n} {\sum }_{i = 1}^{n} {( {X}_{ij} - {\overline{X}}_{j} )}^{2}}}{{\overline{X}}_{j}} \qquad ( 1 - 2 )$$

$${W}_{j} = \frac{{V}_{j}}{{\sum }_{j = 1}^{m} {V}_{j}} \qquad ( 1 - 3 )$$

$$S Q I = {\sum }_{i = 1}^{m} ( {Y}_{i} \times {Y}_{j} ) \qquad ( 1 - 4 )$$

in formula (1-1), Y represents a standardized value of each soil index; x represents a soil index value; n represents an element value of horizontal comparison, n=5; and based on a same logic with the SQI, the comprehensive VQI is calculated on the basis of the four indexes: above-ground vegetation biomass, vegetation coverage, average vegetation height, and vegetation richness.

Further, the ecological governance method based on erosion prevention and control for a gentle slope farmland may further include: subjecting values of the SQI and the VQI to weighted averaging in a ratio of 3:7 to form a ZQI₁ value;

calculating values of the SQI and the VQI for an area not eroded in a same way, and subjecting the values to weighted averaging in the ratio of 3:7 to form a ZQI₂ value;

determining a selected recovery manner based on a ratio S of ZQI₁ to ZQI₂; when 0<S<0.7, determining the soil erosion as serious; when 0.7<<S<0.9, determining the soil erosion as moderate; and when 0.9<<S<1, determining the soil erosion as mild; and

carrying out the natural recovery method for the mild erosion, and carrying out the biological-farming comprehensive recovery method for the moderate erosion and the serious erosion.

Further, the natural recovery method may include: enclosing the gentle slope cultivated land, and reasonably fallowing the gentle slope cultivated land; exterminating insect pests and poisonous weeds in the enclosed area; covering the surface soil layer of the gentle slope. cultivated land with crop straws or rice husk biochar;

after harvesting of autumn crops, smashing straws into 10-20 cm pieces for evenly covering the surface soil layer of the farmland; applying a fertilizer to the covering, where the fertilizer is nitrogenous fertilizer urea, which is applied in an amount of 7.5-10 kg/mu; rowing the covering crop straws at an angle of 20° to 35° along a slope surface in next spring, and covering the covering crop straws with little soil, and carrying out precise non-tillage sowing on the cleared cultivated land; and

carrying out mechanical strip subsoiling between rows of the covering crop straws in mid- to late April to mid-June.

Further, the biological-farming comprehensive recovery method may include: enclosing the gentle slope cultivated land, and reasonably fallowing and gentle slope cultivated land; exterminating insect pests and poisonous weeds in the enclosed area; after harvesting of autumn crops, re-smashing straws into 10-20 cm pieces, and turning the soil to bury the pieces of the straws at a soil layer of 20-30 cm by a cultivator;

after burying the straws, sowing grass seeds and applying a fertilizer to the plowed area, carrying out shallow rotary tillage such that the fertilizer and the grass seeds are evenly distributed in the soil layer, and appropriately watering to fully wet the land; carrying out rotary tillage before sowing in next spring, and carrying out ridging and heavy compacting at the angle of 20° to 35° along the slope surface on the gentle slope cultivated land;

carrying out mechanical strip subsoiling between rows at a subsoiling depth of 30-40 cm in early or mild-June; and sowing triticeae crops between crop rows in late June to early August.

Further, in the biological-farming comprehensive, the grass seeds are mixed seeds of bluegrass, ryegrass, and tall fescue in a ratio of 1:2:2, where the bluegrass is sowed by 2.5 kg/mu, and the other two are each sowed by 5 kg/mu;

a sowing depth is 5 cm, and a soil covering depth is 2-3 cm; when sowing, diammonium phosphate is applied by 8 kg/mu and biochar is applied by 1 kg/mu as fertilizers in a ratio of 8:1; and the sowed triticeae seeds include oat and rye which are mixed in a ratio of 1:1 and each sowed by 5 kg/mu.

### (III) Beneficial Effects

The present disclosure has the following beneficial effects:

Over sowing: of the gentle slope cultivated land is capable of significantly increasing a height, a coverage degree, and above-ground biomass of a plant community and improving the richness and diversity of species, inhibiting the growth of poisonous weeds, and at the same time, improving the quality of the gentle slope cultivated land and reducing water and soil loss. Fertilizer application may promote the growth of gramineous plants that are high in nutrient utilization efficiency, improve the efficiency of transforming biological carbon and nitrogen by microorganisms, and weaken the competitive advantage of poisonous leguminous plant oxytropis ochrocephala and the like. Appropriately applying nitrogen and phosphorus fertilizers can improve the biomass and quality of crops, increase the diversity of species, change the composition and structure of community species, effectively improve the soil fertility level, ameliorate soil erosion, and achieve prevention and control effects.

The growth of poisonous weeds is inhibited. The organic matter content and the soil carbon and nitrogen storage of the gentle slope cultivated land are increased. The diversity of species is increased. The composition and structure of biocoenoses are changed, The soil fertility level is effectively improved. The recovery of the soil ecosystem is promoted. The effects of preventing and controlling soil erosion aggravation are achieved.

By applying biochar and a chemical fertilizer, a good regulation effect can be achieved on the permeability of surface soil. Because of significantly reduced volume weight and obviously increased porosity of the surface soil after the application of the biochar, the air permeability and water permeability of the soil are improved, thus improving the permeability of the surface soil. The surface soil alai can be regulated obviously. This is mainly because the biochar can significantly improve the porosity of the surface soil, reduce the volume weight of the soil, and is conducive to forming a surface soil configuration which is loose in top and tight in bottom.

### BRIEF DESCRIPTION OF THE DRAWINGS

FIG. 1 is a flowchart of an ecological governance method based on erosion prevention and control for a gentle slope farmland according to the present disclosure; and

FIG. 2 is a schematic diagram of ridge plowing for an erosional landform gentle slope farmland according to an embodiment of a method of the present disclosure,

While the above-identified figures set forth one or more embodiments of the present. invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

Soil erodibility refers to a difficulty degree at which soil is dispersed and moved under actions of raindrop splash, runoff scour, and interflow, and is an important index characterizing a soil erosion sensitivity degree and the result of the combined action of soil properties such as soil texture, permeability, and aggregate stability, and rainfall, landform, and soil management measures. Man-made unreasonable use further aggravates the soil erosion of the gentle slope cultivated land and enhances the soil erodibility. Relevant studies indicate that as the years of reclamation and the slope increase, the soil erodibility is enhanced gradually.

### Examples

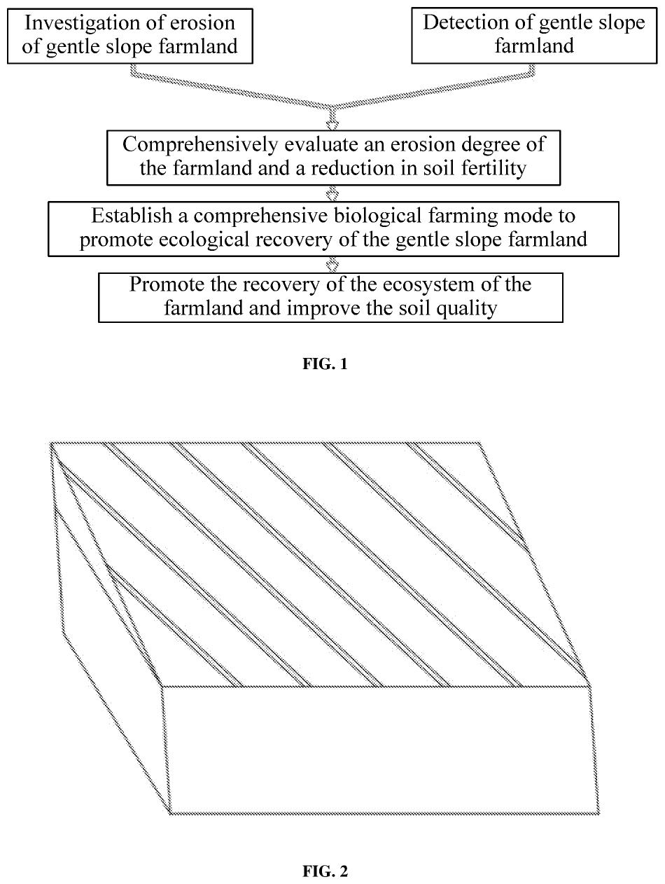

With reference to FIG. 1 and FIG. 2, the present disclosure provides an ecological governance method based on erosion prevention and control for a gentle slope farmland, including the following steps.

Step S1, a gentle slope farmland is sampled to investigate erosion thereof. This step includes the following steps.

S11, a detection quadrat is determined.

A gentle slope farmland is divided into an upper slope, a middle slope, and a lower slope from top to bottom. A rough S-shaped curve is then selected along this area, and a gentle slope between 6 and 25 degrees is determined.

5 quadrats are selected, An area of each quadrat is not less than 1 m². For example, a size of the quadrat is 1 m * 1 m; and a spacing between the quadrats is at least not less than 20 m.

S12, a quadrat vegetation is investigated and sampled.

The quadrat vegetation is investigated. The vegetation coverage in each quadrat is estimated, and an estimated average value is taken as the vegetation coverage in the quadrat. Plant species occurring in each quadrat are recorded. Heights of 10 randomly selected plants are measured and an average value thereof is taken as a species height in the quadrat. The above-ground vegetation biomass is calculated by drying to a constant weight.

S13, quadrat soil is sampled.

Soil samples (0-10 cm, 10-20 cm, 20-30 cm) are taken from 5 layers in the vegetation investigation quadrat. Soil randomly obtained by triple drilling is mixed into a soil sample. The soil sample of each layer is about 500 g and is put in a soil bag for measurement of indexes.

Step S2, erosion samples of the gentle slope farmland are detected. This step includes the following steps.

Upon detection, the following 4 indexes are acquired: above-ground vegetation biomass, vegetation coverage, average vegetation height, and vegetation richness, and the following 7 indexes are acquired: soil organic matter, microbial carbon, soil total nitrogen, soil total phosphorus, soil total potassium, soil available nitrogen, and soil available phosphorus, and evaluating soil erosion of the farmland. The erosion of the unrecovered area under different degradation degrees and different slope grades is calculated for 0-20 cm.

Step S3, a soil nutrient condition is determined to form the SQI.

This step includes the following steps: data of 7 soil indexes is standardized by normalization formulas:

$${Y}_{i} = \frac{{X}_{i} - min \{ {X}_{i} \}}{max \{ {X}_{i} - min \{ {X}_{i} \}} ( 1 \leq i \leq n ) \qquad ( 1 - 1 )$$

In formula (1-1), Y represents a standardized value of each soil index; x represents a soil index value; n represents an element, value of horizontal comparison, n=5.

$${V}_{j} = \frac{\sqrt{\frac{1}{n} {\sum }_{i = 1}^{n} {( {X}_{ij} - {\overline{X}}_{j} )}^{2}}}{{\overline{X}}_{j}} \qquad ( 1 - 2 )$$

$${W}_{j} = \frac{{V}_{j}}{{\sum }_{j = 1}^{m} {V}_{j}} \qquad ( 1 - 3 )$$

$$S Q I = {\sum }_{i = 1}^{m} ( {Y}_{i} \times {Y}_{j} ) \qquad ( 1 - 4 )$$

Under different degradation degrees and different slope grades, each index of the soil has different importance and a different contribution to a comprehensive soil quality index (SQI). Therefore, a weight value of each soil index under different degradation degrees and different slope grades is calculated by a standard deviation coefficient method.

A standard deviation coefficient Vj is calculated by formula (1-2), and then a weight Wj is normalized according to formula (1-3). The comprehensive SQI is then calculated by formula (1-4). The greater the SQI, the higher the soil quality.

Based on a same logic, a comprehensive vegetation quality index (VQI) is calculated on the basis of the four indexes: above-ground vegetation biomass, vegetation coverage, average vegetation height, and vegetation richness.

Further,

the values of the SQI and the VQI are subjected to weighted averaging in a ratio of 3:7 to form a ZQI₁ value, and a current erosion degree of the soil is evaluated. Meanwhile, the values of the SQI and the VQI are calculated for an area not eroded in a same way, and subjected to weighted averaging in the ratio of 3:7 to form a ZQI₂ value.

The current erosion degree of the gentle slope cultivated land is then evaluated based on a ratio of ZQI₁ to ZQI₂.

Finally, a selected recovery manner is determined based on the ratio S of ZQI₁ to ZQI₂. When 0<S<0.7, the soil erosion is determined as serious; when 0.70<<S<0.9, the soil erosion is determined as moderate; and when 0.9<<S<1, the soil erosion is determined as mild.

By determining the erosion and degradation degrees of the gentle slope cultivated lands, for the gentle slope cultivated lands of different erosion degrees, the natural recovery method is carried out for the mild erosion, and the biological-farming comprehensive recovery method is carried out for the moderate erosion and the serious erosion.

The natural recovery method is selected for the mild erosion.

The biological-fanning comprehensive recovery method is selected for the moderate erosion and the serious erosion.

The natural recovery method is as follows: the gentle slope cultivated land is enclosed and reasonably followed (January to May, October to December), and insect pests and poisonous weeds are exterminated in the enclosed area; the surface soil layer of the gentle slope cultivated land is covered with crop straws or rice husk biochar; after harvesting of autumn crops, straws are smashed into 10-20 cm pieces for evenly covering the surface soil layer of the farmland; a fertilizer is applied to the covering, where the fertilizer is nitrogenous fertilizer urea, which is applied in an amount of 7.5-10 kg/mu; the covering crop straws are rowed at an angle of 20° to 35° along a slope surface in next spring, and covered with little soil, and precise non-tillage sowing is carried out on the cleared cultivated land; and mechanical strip subsoiling at a subsoiling depth of 30-40 cm is carried out between rows of the covering crop straws in mid- to late April to mid-June.

The biological-farming comprehensive recovery method may be implemented in the following two different manners.

The first manner is as follows.

The gentle slope cultivated land is enclosed and reasonably fallowed, and insect pests and poisonous weeds are exterminated in the enclosed area. After harvesting of autumn crops, straws are re-smashed into 10-20 cm pieces and buried at the soil layer of 20-30 cm by a cultivator. After burying the straws, grass seeds are sowed and a fertilizer is applied to the plowed area; shallow rotary tillage is carried out such that the fertilizer and the grass seeds are evenly distributed in the soil layer, and the land is fully wetted by appropriate watering; rotary tillage is carried out before sowing in next spring. and ridging and heavy compacting are carried out at the angle of 20° to 35° along the slope surface on the gentle slope cultivated land; mechanical strip subsoiling between rows is carried out at a subsoiling depth of 30-40 cm in early or mild-June; and triticeae crops are sowed between crop rows in late June to early August.

The grass seeds are mixed seeds of bluegrass, ryegrass, and tall fescue in a ratio of 1:2:2, where the bluegrass is sowed by 2.5 kg/mu, and the other two are each sowed by 5 kg/mu; a sowing depth is 5 cm, and a soil covering depth is 2-3 cm; when sowing, diammonium phosphate is applied by 8 kg/mu and biochar is applied by 1 kg/mu as fertilizers in a ratio of 8:1; and the sowed triticeae seeds include oat and rye which are mixed in a ratio of 1:1 and each sowed by 5 kg/mu.

The second manner is as follows.

The gentle slope cultivated land is enclosed and reasonably fallowed, and insect pests and poisonous weeds are exterminated in the enclosed area. After mechanical harvesting of autumn crops, the surface soil layer of the farmland is evenly covered with the crop straws smashed when harvesting, and the smashed crop straws have a length of about 20-35 cm; in next. spring, the crop straws are smashed and mixed into the surface soil by using a disc harrow, and the smashed and mixed crop straws have a length of about 8-18 cm; before sowing, ridging and heavy compacting are carried out at an angle of 20° to 35° along the slope surface on the gentle. slope cultivated land; mechanical strip subsoiling between rows is carried out at a subsoiling depth of 30-35 cm in early June; and grass seeds or triticeae crops are sowed between crop rows in late June or early July, where the grass seeds are mixed seeds of bluegrass, ryegrass, and Festuca sinensis in a ratio of 4:4:1, where the Festuca sinensis is sowed by 1 kg/mu and the other two are each sowed by 4 kg/mu, all sowed between ridges, and where the triticeae seeds include oat, wheat, and rye, each of which is sowed by 4-5 kg/mu and sowed between ridges.

The ecological recovery of the gentle slope cultivated land mainly involves measures such as over sowing on the gentle slope cultivated land, applying a fertilizer, enclosing, returning crop straws to the field, constructing reasonable gentle slope topsoil, and planting on the gentle slope cultivated land. In the recovery process, vegetation and soil are taken as two most important indicative indexes, and variations thereof may visually reflect the erosion and the ecological recovery effect of the cultivated land.

A natural recovery manner is selected for mild degradation.

The gentle slope cultivated land is enclosed and fallowed in mid-April to mid-June, insect pests and poisonous weeds are exterminated by means of insect pest control; after the completion of insect pest extermination, the surface soil layer of the gentle slope cultivated land is covered with straws or rice husk biochar and then covered with a soil layer of about 5-10 cm. After the completion of covering with soil, a fertilizer is applied to the surface of new soil, where the fertilizer is nitrogenous fertilizer urea, which is applied in an amount of 7.5 kg/mu.

For moderate degradation, a technical recovery mode is a manual tractor-ploughing method, which mainly includes the following measures.

The gentle slope cultivated land is enclosed and fallowed, and insect pests and poisonous weeds are exterminated in the enclosed area; ploughing is carried out by an agricultural cultivator, and grass seeds are sowed within the ploughed area; after a fertilizer is applied, the land is ploughed mildly again, and the covering soil is flattened to ensure that the surface is flat. Besides, the fertilizer and the grass seeds are evenly distributed in the soil layer, and the land is fully wetted by appropriate watering.

The grass seeds may be mixed seeds of bluegrass, ryegrass, and tall fescue in a ratio of 1:2:2, where the bluegrass is sowed by 2.5 kg/mu, and the other two are each sowed by 5 kg/mu; a sowing depth is 5 cm, and a soil covering depth is 2-3 cm; and diammonium phosphate is applied as the fertilizer by 8 kg/mu. Moreover, the harvested crop straws are baled into tight square bales using a straw baler. The straws are laid on the flat surface layer of the gentle slope cultivated land as the main buried material and covered with soil by 1-5 cm.

For serious degradation, the technical recovery mode may also be a comprehensive tractor-ploughing method, which mainly includes the following measures.

The gentle slope cultivated land is enclosed and fallowed.

Insect pests and poisonous weeds are exterminated in the enclosed area; ploughing is carried out by an agricultural cultivator, and grass seeds are sowed within the ploughed area; after a fertilizer is applied, the land is ploughed mildly again, and the covering soil is flattened to surer the surface is flat. Besides, the fertilizer and the grass seeds are evenly distributed in the soil layer, and the land is fully wetted by appropriate watering.

The grass seeds may be mixed seeds of bluegrass, ryegrass, and Festuca sinensis in a ratio of 4;4:1, where the Festuca sinensis is sowed by 1 kg/mu and the other two are each sowed by 4 kg/mu; a sowing depth is maintained roughly at 2-3 cm, and a soil coveting depth is 2-3 cm. Fertilizer application amount: when sowing, diammonium phosphate is applied by 9 kg/mu, and the fertilizer is mixed with biochar in a ratio of 1:10. Moreover, the harvested crop straws are baled into tight square bales using a straw baler. The straws are laid on the flat surface layer of the gentle slope cultivated land as the main buried material and covered with soil by 1-5 cm.

Over sowing of the gentle slope cultivated land is capable of significantly increasing a height, a coverage degree, and above-ground biomass of a plant community and improving the richness and diversity of species, inhibiting the growth of poisonous weeds, and at the same time, increasing the nutrient content and the soil carbon and nitrogen storage of the gentle slope cultivated land. Fertilizer application may promote the growth of gramineous plants that are high in nutrient utilization efficiency, increase a proportion thereof in the community, and weaken the competitive advantage of poisonous leguminous plant oxytropis ochrocephala and the like. Appropriately applying nitrogen and phosphorus fertilizers can improve the biomass and quality of crops, increase the diversity of species, change the composition and structure of community species, and effectively improve the soil fertility level. Triticeae and grass plants are resowed on the gentle slope cultivated land so that the richness of species in the soil can be effectively improved, thereby improving the soil fertility level of the cultivated land, reducing water and soil loss, and promoting the recovery of the ecosystem of the gentle slope cultivated land.

By applying biochar and a chemical fertilizer, a good regulation effect can be achieved on the permeability of surface soil. Because of significantly reduced volume weight and obviously increased porosity of the surface soil after the application of the biochar, the air permeability and water permeability of the soil are improved, thus improving the permeability of the surface soil. The surface soil tutu can be regulated obviously. This is mainly because the biochar can significantly improve the porosity of the surface soil, reduce the volume weight of the soil, and is conducive to forming a surface soil configuration which is loose in top and tight in bottom.

Biochar is a porous light substance, and the influences of the biochar on the structure and physical and chemical properties of soil are mainly reflected in aspects of reducing the volume weight of the soil, increasing the porosity of the soil, and improving the permeability of the soil and the soil aggregate, thus improving the erosion resistance of the soil.

By applying the biochar and a chemical fertilizer, the total porosity and the capillary , porosity of the soil of a plough layer (0-20 cm) are improved, where applying the biochar can reduce the volume weight of the soil, improve the stability of the soil aggregate, and prolong the runoff producing time, and may have a good improvement effect on the soil with poor texture and low fertility. The biochar refers to straw biochar or rice husk biochar. The two kinds of biochar are selected for the purposes of increasing the utilization degree of crop materials, reducing waste of resources, and combustion of straws can be directly avoided, thus reducing atmospheric pollution.

Although the embodiments of the present disclosure have been illustrated and described, it should he understood that those of ordinary skill in the art may make various changes, modifications, replacements, and variations to the above embodiments without departing from the principle and spirit of the present disclosure, and the scope of the present disclosure is limited by the appended claims and their legal equivalents.

What is claimed is:

1. An ecological governance method based on erosion prevention and control for a gentle slope farmland, comprising the following steps:
sampling a gentle slope farmland to investigate erosion thereof; and
evaluating an erosion degree of a gentle slope cultivated land and formulating a corresponding recovery strategy based on a detection result of a sample, a soil quality index (SQI), and a comprehensive vegetation quality index (VQI),
wherein the recovery strategy comprises a natural recovery method and a biological-farming comprehensive recovery method.

2. The ecological governance method based on erosion prevention and control for a gentle slope farmland according to claim 1, wherein the sampling a gentle slope farmland to investigate erosion thereof comprises:
determining a detection quadrat, and investigating and sampling a quadrat vegetation: sampling quadrat soil, wherein the detection quadrat is determined as follows: determining a gentle slope between 6 and 25 degrees; and
selecting 5 quadrats along an S-shaped curve on the gentle slope, wherein an area of each quadrat is not less than 1 m²; and a spacing between the quadrats is at least not less than 20 m.

3. The ecological governance method based on erosion prevention and control for a gentle slope farmland according to claim 1, wherein the investigating and sampling a quadrat vegetation comprises:
investigating the quadrat vegetation to acquire four indexes: above-ground vegetation biomass, vegetation coverage, average vegetation height, and vegetation richness; and
taking soil samples from five layers in each quadrat, mixing soil obtained by triple drilling into a soil sample for measurement of the indexes; acquiring seven indexes: soil organic matter, microbial carbon, soil total nitrogen, soil total phosphorus, soil total potassium, soil available nitrogen, and soil available phosphorus, and evaluating soil erosion of the farmland.

4. The ecological governance method based on erosion prevention and control for a gentle slope farmland according to claim 3, wherein data of the seven soil indexes is standardized by normalization formulas:
$${Y}_{i} = \frac{{X}_{i} - min \{ {X}_{i} \}}{max \{ {X}_{i} - min \{ {X}_{i} \}} ( 1 \leq i \leq n ) \qquad ( 1 - 1 )$$
$${V}_{j} = \frac{\sqrt{\frac{1}{n} {\sum }_{i = 1}^{n} {( {X}_{ij} - {\overline{X}}_{j} )}^{2}}}{{\overline{X}}_{j}} \qquad ( 1 - 2 )$$
$${W}_{j} = \frac{{V}_{j}}{{\sum }_{j = 1}^{m} {V}_{j}} \qquad ( 1 - 3 )$$
$$S Q I = {\sum }_{i = 1}^{m} ( {Y}_{i} \times {Y}_{j} ) \qquad ( 1 - 4 )$$
in formula (1-1), Y represents a standardized value of each soil index; x represents a soil index value; n represents an element value of horizontal comparison, n=5; and based on a same logic with the SQI, the comprehensive VQI is calculated on the basis of the four indexes: above-ground vegetation biomass, vegetation coverage, average vegetation height, and vegetation richness.

5. The ecological governance method based on erosion prevention and control for a gentle slope farmland according to claim 4, further comprising: subjecting values of the SQI and the VQI to weighted averaging in a ratio of 3:7 to form a ZQI₁ value;
calculating values of the SQI and the VQI for an area not eroded in a same way, and subjecting the values to weighted averaging in the ratio of 3:7 to form a ZQI₂ value;
determining a selected recovery manner based on a ratio S of ZQI₁ to ZQI₂;
when 0<S<0.7, determining the soil erosion as serious; when 0.7<<S<0.9, determining the soil erosion as moderate; and when 0.9<<S<1, determining the soil erosion as mild; and
carrying out the natural recovery method for the mild erosion, and carrying out the biological-farming comprehensive recovery method for the moderate erosion and the serious erosion.

6. The ecological governance method based on erosion prevention and control for a gentle slope farmland according to claim 5, wherein the natural recovery method comprises:
enclosing the gentle slope cultivated land, and reasonably fallowing the gentle slope cultivated land; exterminating insect pests and poisonous weeds in the enclosed gentle slope cultivated land; covering a surface soil layer of the gentle slope cultivated land with crop straws or rice husk biochar;
after harvesting of autumn crops, smashing straws into 10-20 cm pieces for evenly covering the surface soil layer of the farmland; applying a fertilizer to the covering, wherein the fertilizer is nitrogenous fertilizer urea, which is applied in an amount of 7.5-10 kg/mu;
rowing the covering crop straws at an angle of 20° to 35° along a slope surface in next spring, and covering the covering crop straws with little soil, and carrying out precise non-tillage sowing on the cultivated land; and
carrying out mechanical strip subsoiling between rows of the covering crop straws in mid- to late April to mid-June.

7. The ecological governance method based on erosion prevention and control for a gentle slope farmland according to claim 5, wherein the biological-farming comprehensive recovery method comprises:
enclosing the gentle slope cultivated land, and reasonably fallowing and gentle slope cultivated land; exterminating insect pests and poisonous weeds in the enclosed gentle slope cultivated land;
after harvesting of autumn crops, re-smashing straws into 10-20 cm pieces, and turning the soil to bury the pieces of the straws at a soil layer of 20-30 cm by a cultivator;
after burying the straws, sowing grass seeds and applying a fertilizer to the burying area, carrying out shallow rotary tillage such that the fertilizer and the grass seeds are evenly distributed in the soil layer, and appropriately watering to fully wet the land;
carrying out rotary tillage before sowing in next spring, and carrying out ridging and heavy compacting at an angle of 20° to 35° along the slope surface on the gentle slope cultivated land; carrying out mechanical strip subsoiling between rows at a subsoiling depth of 30-40 cm in early or mild-June; and sowing triticeae crops between crop rows in late June to early August.

8. The ecological governance method based on erosion prevention and control for a gentle slope farmland according to claim 7, wherein in the biological-farming comprehensive recovery method, the grass seeds are mixed seeds of bluegrass, ryegrass, and tall fescue in a ratio of 1:2:2, wherein the bluegrass is sowed by 2.5 kg/mu, and the ryegrass and the tall fescue are each sowed by 5 kg/mu;
a sowing depth is 5 cm, and a soil covering depth is 2-3 cm; when sowing, diammonium phosphate is applied by 8 kg/mu and biochar is applied by 1 kg/mu as fertilizers in a ratio of 8:1; and the sowed triticeae crops comprise oat and rye seeds which are mixed in a ratio of 1:1 and each sowed by 5 kg/mu.
